(19) United States
(12) Patent Application Publication
(10) Pub. No.: US 2024/0383581 A1
(43) Pub. Date: Nov. 21, 2024

(54) VISUAL INTERFACE FOR VEHICLES

(71) Applicant: Ronan ., Winter Garden, FL (US)

(72) Inventor: Ronan ., Winter Garden, FL (US)

(21) Appl. No.: 18/665,099

(22) Filed: Jun. 4, 2024

Related U.S. Application Data
(60) Provisional application No. 63/466,752, filed on May 16, 2023.

(51) Int. Cl. B63B 49/00; G02B 27/00; G02B 27/01; G06F 3/01

(52) U.S. Cl. CPC B63B 49/00; G02B 27/0093; G02B 27/0101; G02B 27/017; G06F 3/013; G02B 2027/0138; G02B 2027/014; G02B 2027/0178

(57) ABSTRACT

A visual interface device includes a computing device, a transparent display, a perception sensor configured to communicate signals indicative of a user's vision to the computing device, and a communication module configured to receive vehicle data from a controller of a vehicle and communicate the vehicle data to the computing device. The computing device is configured to generate a visual overlay based on the signals received from the perception sensor and the vehicle data received from the communication module. The computing device is further configured to instruct the transparent display to display the visual overlay over the user's vision.

### CROSS-REFERENCE TO RELATED APPLICATION

This application claims priority from U.S. Non-Provisional Patent Application No. 63/466,752 filed on May 16, 2023.

### BACKGROUND

For safety reasons operators of motorized vehicle should be encouraged to keep their eyes forward in the direction of travel so they can react to their environment and reduce the risk of an accident. It is also beneficial for operators to be informed about operating conditions of their vehicle and details of their surroundings. In typical vehicles however this information is displayed away from the forward direction of travel and requires the operator to look elsewhere to view the information.

Accordingly, there exists a need for a device that can provide information to an operator while allowing them to keep their gaze forward. In addition to safety benefits, there also exists a need for a device that can provide an augmented and/or enhanced reality for a vehicle operator which provides easily accessible information from a verity of sources as a visual overlay.

### SUMMARY

In one exemplary embodiment, a visual interface device includes a computing device, a transparent display, a perception sensor configured to communicate signals indicative of a user's vision to the computing device, and a communication module configured to receive vehicle data from a controller of a vehicle and communicate the vehicle data to the computing device. The computing device is configured to generate a visual overlay based on the signals received from the perception sensor and the vehicle data received from the communication module. The computing device is further configured to instruct the transparent display to display the visual overlay over the user's vision.

In another embodiment according to any of the previously described embodiments, the visual interface device further includes a user interface configured to communicate user inputs to the computing device. The computing device is further configured to generate a visual overlay based on the user inputs received from the user interface.

In another embodiment according to any of the previously described embodiments, the vehicle data includes operating characteristics of the vehicle, and the computing device is configured to generate a visual overlay based on the operating characteristics which displays at least one of engine RPM, engine temperature, engine water pressure, engine oil pressure, vehicle battery charge, and vehicle fuel level.

In another embodiment according to any of the previously described embodiments, the vehicle data includes environmental information relating to the vehicle's surroundings.

In another embodiment according to any of the previously described embodiments, the computing device is configured to generate a visual overlay based on the environmental information wherein hazards surrounding the vehicle are highlighted in the user's vision.

In another embodiment according to any of the previously described embodiments, the computing device is configured to generate a visual overlay based on the environmental information which displays a virtual representation of underwater objects.

In another embodiment according to any of the previously described embodiments, the computing device is configured to generate a visual overlay based on the environmental information which displays virtual representations of the real-time location of underwater marine life.

In another embodiment according to any of the previously described embodiments, the computing device is configured to generate a visual overlay based on the environmental information which displays safe boundaries for the vehicle to travel within.

In another embodiment according to any of the previously described embodiments, the vehicle data includes at least one of positional and navigational information of the vehicle, and the computing device is configured to generate a visual overlay including at least one of a virtually generated waypoint and a directional guidance arrow.

In another exemplary embodiment, a visual interface system includes a vehicle controller receiving vehicle data from a sensor system mounted to a vehicle and a visual interface device. The visual interface device includes a computing device, a transparent display, a perception sensor configured to communicate signals indicative of a user's vision to the computing device, and a communication module configured to receive the vehicle data from the vehicle controller and communicate the vehicle data to the computing device. The computing device is configured to generate a visual overlay based on the signals received from the perception sensor and the vehicle data received from the communication module. The computing device is further configured to instruct the transparent display to display the visual overlay over the user's vision.

In another embodiment according to any of the previously described embodiments, the sensor system includes one or more movement sensors and the vehicle data includes movement characteristics of the vehicle communicated to the vehicle controller by the by the one or more movement sensors. The one or more movement sensors comprise at least one of an accelerometer, an inertial measurement unit, a pitometer, and a magnetic sensor. The computing device is configured to generate a visual overlay based on the movement characteristics which displays at least one of a speed of the vehicle, an acceleration of the vehicle, and a movement direction of the vehicle.

In another embodiment according to any of the previously described embodiments, the sensor systems includes one or more mechanical sensors, and the vehicle data includes operating characteristics of the vehicle communicated to the vehicle controller by the one or more mechanical sensors. The computing device is configured to generate a visual overlay which displays at least one of engine RPM, engine temperature, engine water pressure, engine oil pressure, vehicle battery charge, and vehicle fuel level.

In another embodiment according to any of the previously described embodiments, the sensor system includes one or more environmental sensors, and the vehicle data includes environmental information relating to the vehicle's surroundings communicated to the vehicle controller by the one or more environmental sensors. The one or more environmental sensors comprise at least one of sonar, radar, LiDAR, cameras, and transducers.

In another embodiment according to any of the previously described embodiments, the computing device is configured to generate a visual overlay based on the environmental information wherein hazards surrounding the vehicle are highlighted in the user's vision.

In another embodiment according to any of the previously described embodiments, the computing device is configured to generate a visual overlay based on the environmental information which displays a virtual representation of underwater objects.

In another embodiment according to any of the previously described embodiments, the computing device is configured to generate a visual overlay based on the environmental information which displays virtual representations of the real-time locations of underwater marine life.

In another embodiment according to any of the previously described embodiments, the computing device is configured to generate a visual overlay based on the environmental information which displays safe boundaries for the vehicle to travel within.

In another embodiment according to any of the previously described embodiments, the sensor system includes one or more navigational sensors, and the vehicle data includes at least one of positional and navigational information of the vehicle communicated to the vehicle controller by the one or more navigational sensors. The computing device is configured to generate a visual overlay including at least one of a virtually generated waypoint and a directional guidance arrow.

In another embodiment according to any of the previously described embodiments, the communication module is further configured to receive incoming communications, and wherein the computing device is configured to generate a visual overlay which displays the incoming communications.

### BRIEF DESCRIPTION OF THE DRAWINGS

FIG. 1 schematically illustrates a visual interface device for use with vehicles.

FIG. 2 illustrates a first example visual overlay of the visual interface device.

FIG. 3 illustrates a second example visual overlay of the visual interface device.

FIG. 4 illustrates a third example visual overlay of the visual interface device.

FIG. 5 illustrates a fourth example visual overlay of the visual interface device.

### DETAILED DESCRIPTION

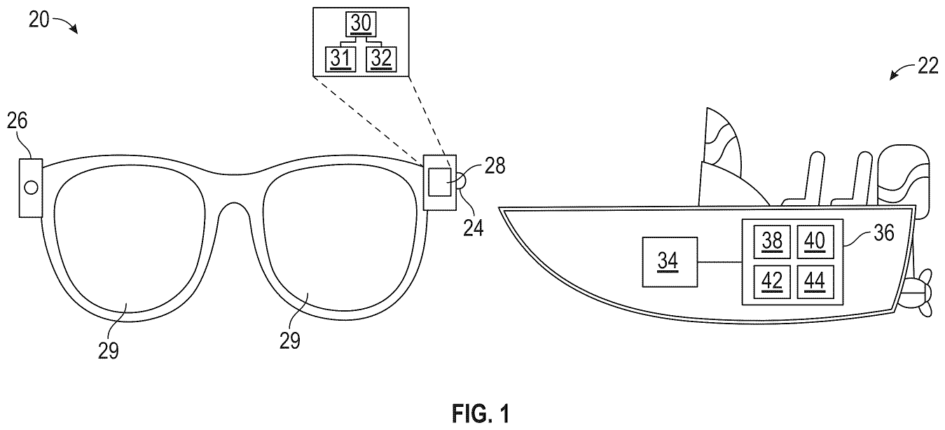

FIG. 1 schematically illustrates a visual interface device 20 for vehicles 22 that provides an informational overlay to a vehicle operator's field of view. In an example, the visual interface device 20 is wearable by the vehicle operator. For example, the visual interface device 20 may be configured as goggles, glasses, lenses, or any other screen positioned in front of the eyes of the operator. In a non-limiting example, the vehicle 22 may be a boat or other water vehicle. In other non-limiting examples, the vehicle 22 is an automobile or airplane, however it should be understood that the visual interface device 20 may be used with any type of vehicle.

In an example, the visual interface device 20 includes a user interface 24, perception sensors 26, a computing device 28, and a transparent display 29. The user interface 24 allows an operator to turn on and off the visual interface device 20 and instruct the visual interface device 20 on which information to display. The user interface 24 may generally comprise buttons or a touch pad via, for example, a Bluetooth or other wireless connection. The user interface 24 may also comprise software of the computing device 28, such as speech recognition software, gesture recognition software, or software to enable the visual interface device 20 to be controlled remotely via a remote control, such as a separate touch screen or a smartphone app.

The perception sensors 26 may comprise one or more of a camera, a magnetometer, an accelerometer, gyroscopic sensors, and/or any sensor capable of tracking movement and positioning, including the movement of a user's eyes. In examples where the perception sensors 26 include a camera, the camera may be directed forward on the visual interface device 20 to capture real-time images of the operator's field of view. The perception sensor 26 communicates signals indicative of the operator's orientation, perception or field of view to the computing device 28.

The computing device 28 includes processing circuitry 30 operatively connected to a memory 31 and a communication module 32. The processing circuitry 30 may include one or more microprocessors, microcontrollers, application specific integrated circuits (ASICs), or the like. The memory 31 can include can include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.). Moreover, the memory 31 may incorporate electronic, magnetic, optical, and/or other types of storage media. The memory 31 can also have a distributed architecture, where various components are situated remotely from one another, but can be accessed by the processing circuitry 30. As discussed further below, the processing circuitry 30 determines what information to display to the operator and where in the operator's field of view to overlay the information.

The communication module 32 of the computing device 28 is configured to communicate with and/or receive data from a vehicle controller 34 of a vehicle 22 being operated by the operator. The communication module 32 is further configured to communicate with the user interface 24 and the transparent display 29. The communication module 32 may also allow the visual interface device 20 to communicate with any other external source of data, such as a mobile phone of the operator. The communication module 32 may incorporate a wireless connection, such as a Bluetooth connection, or a direct wired connection.

The communication module 32 allows the vehicle controller 34 and other external sources to communicate signals indicative of various information to the processing circuitry 30 of the visual interface device 20. This information may then be analyzed and processed by the processing circuitry 30 to generate a visual overlay which adds useful information to the operator's field of view. The processing circuitry 30 then instructs the transparent display 29 to generate a visual overlay accordingly. The transparent display 29 may comprise any known method of displaying augmented reality to a user, such as, but not limited to, a curved mirror display or a waveguide display.

The vehicle 22 further includes a sensor system 36 communicating with the vehicle controller 34. In some examples, the vehicle controller 34 and sensor system 36 are directly integrated into the vehicle 22 during manufacturing of the vehicle 22, i.e., are part of a factory standard package of the vehicle 22. In other examples, the vehicle controller 34 and/or sensor system 36 are aftermarket components that are added to the vehicle 22. The sensor system 36 may include a plurality of aftermarket sensors that each individually communicate with the vehicle controller 34. In further examples, a vehicle controller 34 is not included and sensors of the sensor system 36 communicate directly with the communication module 32 of the visual interface device 20.

The sensor system 36 may include mechanical sensors 38, movement sensors 40, navigational sensors 42, and environmental sensors 44. The mechanical sensors 38 are operable to detect and communicate signals indicative of operating characteristics of the vehicle 22, such as engine RPM, engine temperature, engine water pressure, engine oil pressure, vehicle battery charge, vehicle fuel level, etc. Movement sensors 40 may comprise accelerometers, inertial measurement units (IMU), pitometers, magnetic sensors, or any other appropriate sensor to detect and communicate signals indicative of movement characteristics of the vehicle 22, such as speed, acceleration, direction, heading, etc. The navigational sensors 42 may comprise a GPS system, or any other appropriate sensors operable to detect and communicate positional and navigational information. The environmental sensors 44 may comprise sonar, radar, LiDAR, cameras, transducers or any other appropriate sensor operable to detect and communicate signals indicative of environmental information, i.e., information relating to the vehicle's 22 surroundings. The sensor system 36 communicates signals of the detected information to the vehicle controller 34, which, in turn, communicates that information to the computing device 28 of the visual interface device 20 through the communication module 32.

The communication module 32 may also be configured to receive information related to communications or entrainment from the vehicle 22 or any other external source. For example, the communication module 32 may be configured to receive information relating to text messages or other incoming communications from an operator's smartphone. The communication module 32 may also receive information related to visual or audible entertainment from a vehicle entertainment system or any other external entertainment source. The communication module 32 delivers this communication and entertainment information to the computing device 28 of the visual interface device 20.

The computing device 28 of the visual interface device 20 analyzes (1) desired user settings communicated by the user interface 24, (2) the real-time perception data communicated by the perception sensors 26 of the visual interface device 20, and (3) any information provided via the sensor system 36 of the vehicle 22 or other external source in order to generate a visual overlay of information to be provided to the operator through the transparent display 29.

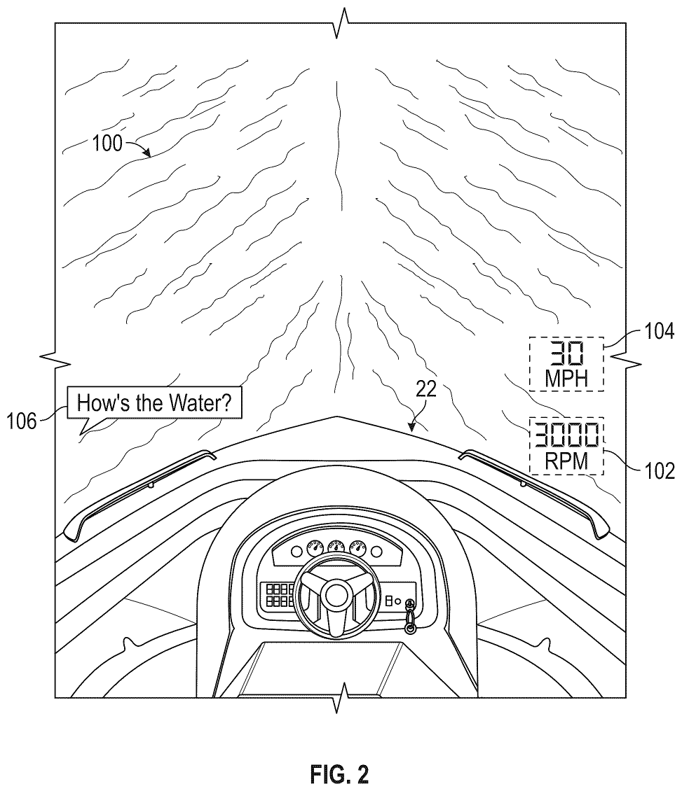

FIG. 2 illustrates a first example visual overlay 100 providing operating characteristics 102 and movement characteristics 104 of the vehicle 22, as well as communications 106. In an example, an operator may use the user interface 24 to select specific operating and/or movement characteristics 102, 104 of the vehicle 22 for the visual interface device 20 to display. The selected information is provided to the computing device 28 of the visual interface device 20 by the mechanical sensors 38 or movement sensors 40, respectively. An operator may also use the user interface 24 to instruct the visual interface device 20 to display incoming communications 106 (i.e., text messages) or visual entertainment. The computing device 28 then instructs the transparent display 29 to provide a visual overlay including the desired information or images. As shown in the first example visual overlay 100, the desired information or images may be provided towards the periphery of the operator's field of view so as not to distract or obstruct the operator's vision, but still allow easy access without significantly removing the operator's view from the direction of travel.

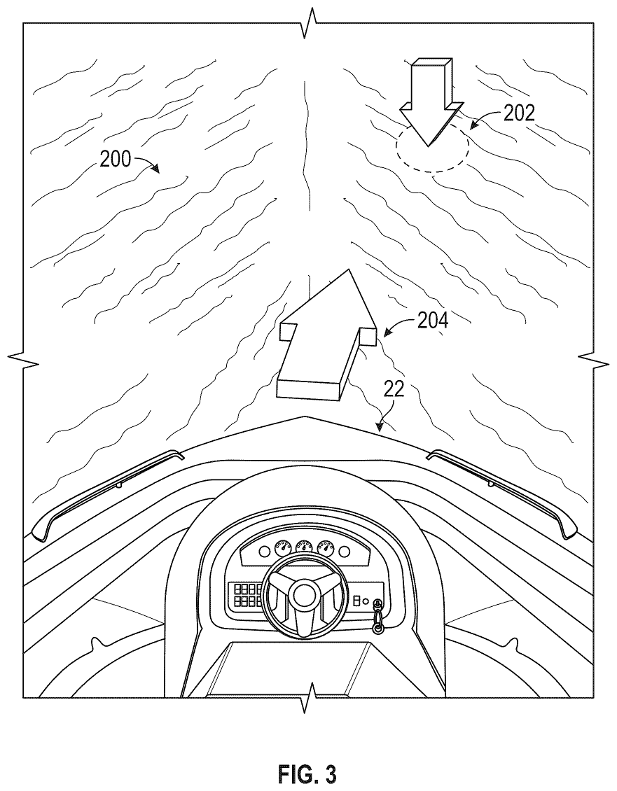

FIG. 3 illustrates a second example visual overlay 200 providing navigational cues to an operator wearing the visual interface device 20. In an example, the operator may input navigational information, such as a desired course or destination, with the user interface 24. Using information communicated by the navigational sensors 42, the computing device 28 of the visual interface device 20 instructs the transparent display 29 to provide a visual overlay that will guide the operator along the desired course or direction. For example, as shown in the second example visual overlay 200, a virtually generated waypoint 202 or a directional guidance arrow 204 may be displayed in the vehicle operator's field of view.

In another example, the visual interface device 20 may be useful in search and rescue operations, for example a waypoint 202 may be generated to show the location of another vehicle or person in distress. In an example, the communication module 32 is configured to receive location data of the vehicle or person in need of help from an external source, such as from a communication system of that vehicle or from a smartphone.

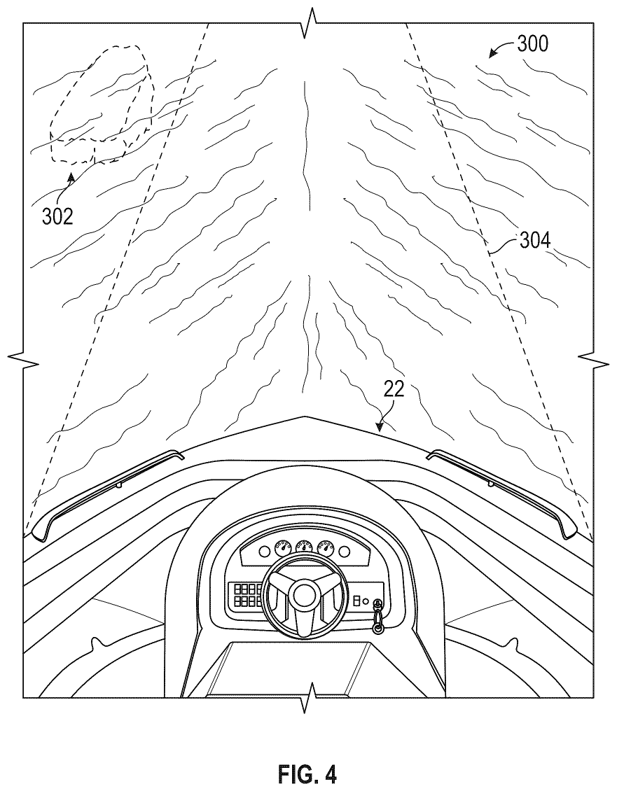

FIG. 4 illustrates a third example visual overlay 300 providing information for collision avoidance. Using information provided by the environmental sensors 44, the computing device 28 of the visual interface device 20 may instruct the transparent display 29 to generate a visual overlay that highlights or makes visible certain objects or features in the operator's field of view. For example, the environmental sensors 44 may detect objects or hazards surrounding the vehicle and the computing device 28 may instruct a visual overlay that highlight's such objects or hazards in the operator's field of view. In examples where the vehicle 22 is a boat or other water vehicle, the visual overlay may make visible certain objects and hazards that are underwater, and thus somewhat obstructed from the operator's vision. For example, as shown in the third example visual overlay 300, the computing device 28 may instruct the transparent display 29 to generate a virtual representation of underwater structures 302 (here, a rock) such that, to the operator, it appears that they can clearly see submerged objects and hazards through the water's surface.

The third example visual overlay 300 further includes a virtual representation of a boundary or safe channel 304 with appropriate water depth for the vehicle 22 to travel within. In an example, the environmental sensors 44 may detect water depth in the area surrounding the water vehicle 22 and the computing device 28 may use this information to generate a visual overlay including boundaries or safe channels. In another example, the memory 31 of the visual interface device 20 may store data of water depth information for a given body of water and the computing device 28 may generate visual overlays including safe boundaries or channels using the stored water depth information.

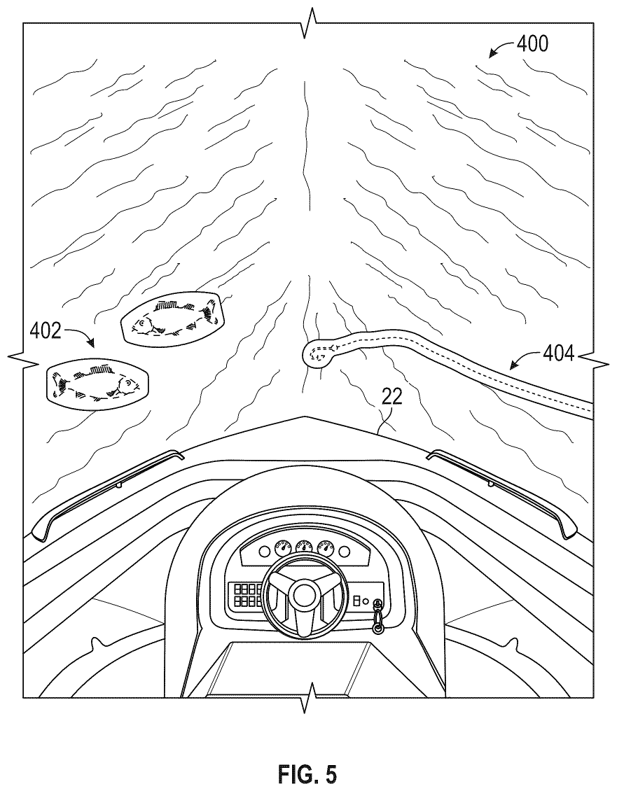

FIG. 5 illustrates a fourth example visual overlay 400 useful for commercial and recreational fishing. In examples, the environmental sensors 44 may be operable to detect fish and other marine life in the area surrounding a water vehicle 22. The environmental sensors 44 may further be configured to allow for differentiation of different types of marine life surrounding the water vehicle 22. The environmental sensors 44 may also be operable to detect the presence and location of fishing equipment under the water, such as fishing lines, fishing lures, and/or fishing bait. Using this information communicated by the environmental sensors 44, the computing device 28 of the visual interface device 20 may instruct the transparent display 29 to generate a visual overlay, such as the fourth example visual overlay 400, which includes virtual representations of the real-time location and movement of marine life 402 and fishing equipment 404 under the water's surface. Accordingly, the visual overlay provided by the visual interface device 20 makes it appears as though the operator fisherman can see through the water's surface to clearly see their fishing equipment 404 and the real-time location of marine life 402 in the proximity of the vehicle 22. In some examples, the marine life 402 and fishing equipment 404 are highlight or emphasized in the visual overlay 400 for easier detection and tracking by the operator. Further, the visual overlay 400 may further includes an indication of the type of marine life 402 (i.e. species of fish).

The visual interface device 20 allows an operator of a vehicle 22 to receive useful information while keeping their eyes forward in the direction of travel. The visual interface device 20 further allows the operator of a water vehicle 22 to easily see underwater objects and hazards that may not otherwise be visible. In addition, the visual interface device 20 may provide a significant advantage to anglers by allowing them to clearly see and track fish and other marine life under the water's surface. The visual interface device 20 generally provides easily accessible information that improves the vehicle operator's ability to perform an intended task, such as driving, piloting, navigating, fishing, etc.

Although a combination of features is shown in the illustrated examples, not all of them need to be combined to realize the benefits of this disclosure. In other words, a system designed according to an embodiment of this disclosure will not necessarily include all of the features shown in any one of the Figures or all of the portions schematically shown in the figures. Moreover, selected features of one example embodiment may be combined with select features of other example embodiments.

The proceeding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A visual interface device comprising:
a computing device;
a transparent display;
a perception sensor configured to communicate signals indicative of a user's vision to the computing device;
a communication module configured to receive vehicle data from a controller of a vehicle and communicate the vehicle data to the computing device;
wherein the computing device is configured to generate a visual overlay based on the signals received from the perception sensor and the vehicle data received from the communication module; and
wherein the computing device is configured to instruct the transparent display to display the visual overlay over the user's vision.

2. The visual interface device of claim 1, further comprising a user interface configured to communicate user inputs to the computing device, and wherein the computing device is further configured to generate a visual overlay based on the user inputs received from the user interface.

3. The visual interface device of claim 1, wherein the vehicle data includes movement characteristics of the vehicle, and the computing device is configured to generate a visual overlay based on the movement characteristics which displays at least one of a speed of the vehicle, an acceleration of the vehicle, and a movement direction of the vehicle.

4. The visual interface device of claim 1, wherein the vehicle data includes operating characteristics of the vehicle, and the computing device is configured to generate a visual overlay based on the operating characteristics which displays at least one of engine RPM, engine temperature, engine water pressure, engine oil pressure, vehicle battery charge, and vehicle fuel level.

5. The visual interface device of claim 1, wherein the vehicle data includes environmental information relating to the vehicle's surroundings.

6. The visual interface device of claim 5, wherein the computing device is configured to generate a visual overlay based on the environmental information wherein hazards surrounding the vehicle are highlighted in the user's vision.

7. The visual interface device of claim 5, wherein the computing device is configured to generate a visual overlay based on the environmental information which displays a virtual representation of underwater objects.

8. The visual interface device of claim 5, wherein the computing device is configured to generate a visual overlay based on the environmental information which displays virtual representations of the real-time location of underwater marine life.

9. The visual interface device of claim 5, wherein the computing device is configured to generate a visual overlay based on the environmental information which displays safe boundaries for the vehicle to travel within.

10. The visual interface device of claim 1, wherein the vehicle data includes at least one of positional and navigational information of the vehicle, and the computing device is configured to generate a visual overlay including at least one of a virtually generated waypoint and a directional guidance arrow.

11. A visual interface system comprising:
a vehicle controller receiving vehicle data from a sensor system mounted to a vehicle;
a visual interface device, the visual interface device including:
a computing device;
a transparent display;
a perception sensor configured to communicate signals indicative of a user's vision to the computing device;
a communication module configured to receive the vehicle data from the vehicle controller and communicate the vehicle data to the computing device;
wherein the computing device is configured to generate a visual overlay based on the signals received from the perception sensor and the vehicle data received from the communication module; and
wherein the computing device is configured to instruct the transparent display to display the visual overlay over the user's vision.

12. The visual interface system of claim 11, wherein:
the sensor system includes one or more movement sensors;
the vehicle data includes movement characteristics of the vehicle communicated to the vehicle controller by the by the one or more movement sensors;
the one or more movement sensors comprise at least one of an accelerometer, an inertial measurement unit, a pitometer, and a magnetic sensor; and
the computing device is configured to generate a visual overlay based on the movement characteristics which displays at least one of a speed of the vehicle, an acceleration of the vehicle, and a movement direction of the vehicle.

13. The visual interface system of claim 11, wherein:
the sensor systems includes one or more mechanical sensors;
the vehicle data includes operating characteristics of the vehicle communicated to the vehicle controller by the one or more mechanical sensors; and
the computing device is configured to generate a visual overlay which displays at least one of engine RPM, engine temperature, engine water pressure, engine oil pressure, vehicle battery charge, and vehicle fuel level.

14. The visual interface system of claim 11, wherein:
the sensor system includes one or more environmental sensors;
the vehicle data includes environmental information relating to the vehicle's surroundings communicated to the vehicle controller by the one or more environmental sensors;
the one or more environmental sensors comprise at least one of sonar, radar, LiDAR, cameras, and transducers.

15. The visual interface system of claim 14, wherein the computing device is configured to generate a visual overlay based on the environmental information wherein hazards surrounding the vehicle are highlighted in the user's vision.

16. The visual interface system of claim 14, wherein the computing device is configured to generate a visual overlay based on the environmental information which displays a virtual representation of underwater objects.

17. The visual interface system of claim 14, wherein the computing device is configured to generate a visual overlay based on the environmental information which displays virtual representations of the real-time locations of underwater marine life.

18. The visual interface system of claim 14, wherein the computing device is configured to generate a visual overlay based on the environmental information which displays safe boundaries for the vehicle to travel within.

19. The visual interface system of claim 11, wherein:
the sensor system includes one or more navigational sensors;
the vehicle data includes at least one of positional and navigational information of the vehicle communicated to the vehicle controller by the one or more navigational sensors; and
the computing device is configured to generate a visual overlay including at least one of a virtually generated waypoint and a directional guidance arrow.

20. The visual interface system of claim 11, wherein the communication module is further configured to receive incoming communications, and wherein the computing device is configured to generate a visual overlay which displays the incoming communications.
